(19) United States
(12) Patent Application Publication
(10) Pub. No.: US 2021/0356667 A1
(43) Pub. Date: Nov. 18, 2021

(54) OPTICAL FIBRE CLEAVING TOOL

(71) Applicant: OXFORD FIBER LTD, Rugby (GB)

(72) Inventors: Ian MURGATROYD, Rugby (GB); Edward John Phillip Kearney, Rugby (GB); Kazimierz Krzysztof WOJEWODA, Rugby (GB); Ivo Anthony RADICE, Rugby (GB)

(73) Assignee: OXFORD FIBER LTD, Rugby (GB)

(21) Appl. No.: 17/278,304

(22) PCT Filed: Sep. 13, 2019
(86) PCT No.: PCT/GB2019/052574

§ 371 Date: Mar. 20, 2021

(30) Foreign Application Priority Data
Sep. 21, 2018 (GB) 1815406.2
Sep. 12, 2019 (GB) 1913205.9

(51) Int. Cl. G02B 6/25

(52) U.S. Cl. CPC G02B 6/25; G02B 6/3885

(57) ABSTRACT

A cleaving tool is provided for cleaving ribbon fibres with two or more optical fibres. The cleaving tool has a cutting assembly, and a clamping means with a datum plane and at least one clamping portion. The clamping means is configured to clamp two or more of the optical fibres against the datum plane; and the clamping means is configured to apply an equal clamping force to each of the optical fibres within the ribbon fibre.

### TECHNICAL FIELD

The invention relates to the field of optical fibre cleavers. Specifically, the invention relates to devices for cleaving ribbon optical fibres.

### BACKGROUND

One known method of terminating or connectorising optical fibre is to strip off its protective coating and to break the optical fibre. The exposed end is polished to remove any defects and ensure a clean connection can be obtained with the next fibre or a connector and thus minimise signal losses. When installing fibre networks in the field, such polishing is not feasible, and thus an alternative technique of cleaving the fibre is used to leave an exposed end with a very predictable end profile. A range of optical fibre cleavers are currently available, for example by the present inventor, for cleaving optical fibres, for example, in order to connect the fibre to an opto-electronic device or to further fibres. The cleaved end of the fibre may be perpendicular to the axis of the fibre or it may be slightly angled, typically 8°, relative to the perpendicular. Such angled cleaving minimises back reflection within the fibre core and thus reduces interference and signal losses to acceptable levels.

Optical fibres which contain multiple parallel optical fibres are commonly referred to as ribbon fibres. Existing common optical fibre cleavers are configured to cleave single fibres at a time, and thus connecting a ribbon fibre in the field using these cleavers is not practical. Alternative cleavers are able to cleave ribbon fibres, but are typically not as accurate or effective in cleaving all of the fibres equally well or as well as an existing single fibre cleaver would cleave a single fibre.

### SUMMARY OF INVENTION

The general technique of cleaving optical fibres is discussed in the inventor's earlier patent applications, such as WO/GB98/01598 and GB2501974.

Ribbon fibre cleavers are typically not able to cleave fibre ribbons with ends reliably angled at 8° from the perpendicular and so optical back-reflection is likely to occur Another problem is in cleaving the fibre so that each of the exposed ends of optical fibre are the same length. When joining a pair of cleaved ribbon fibres, any minor errors are amplified, and problems such as unequal cleave lengths can affect all of the fibres within the ribbon.

It is thus desirable to provide an optical fibre cleaver which can resolve or ameliorate one or more of the existing problems of the prior art.

According to a first aspect of the invention, there is provided a cleaving tool for cleaving optical fibres. The cleaving tool may comprise a cutting assembly. The cleaving tool may comprise a clamping means. The clamping means may comprise a datum plane. The clamping means may comprise at least one clamping portion. The at least one clamping portion may be configured to clamp at least one optical fibre against the datum plane. The clamping means may comprise a compressible surface. The compressible surface may, in use, be compressed against the at least one optical fibre. The compressible surface may be compressible by less than the diameter of the at least one optical fibre.

The cutting assembly may comprise a blade. The cutting assembly may comprise an anvil. The anvil may be configured to apply a force to an optical fibre in a cutting process. The anvil may be configured to deflect or bend an optical fibre away from the datum plane in a cutting process. The clamping means may be a clamp or clamping mechanism.

The cleaving tool may comprise a biasing mechanism configured to apply a biasing force to the cutting assembly and/or clamping means. The biasing force may be configured to resist the force applied by a user during a cleaving process. The biasing mechanism may be configured to provide a two-stage resistance. The biasing mechanism may comprise one or more springs. The biasing mechanism may be configured to prevent a cleaving process until a sufficient force has been applied by a user, for example, the biasing mechanism may provide a threshold which must be overcome during a cleaving process. The biasing mechanism and/or threshold may be configured to ensure that the optical fibre is clamped with sufficient force before the optical fibre is cleaved by the cutting assembly.

The compressible surface may be resiliently deformable. The compressible surface may be formed on or provided by a surface coating or an insert.

The invention is particularly advantageous, since the compressible surface allows for improved clamping of an optical fibre. The present inventors have found that surfaces which are too compressible (e.g. too soft or too thick) do not clamp the optical fibre sufficiently and cause defects in the cleave. Furthermore, with surfaces which are too hard, for example metal clamping surfaces, it has been found that the optical fibre is prone to slipping through the clamping means or the optical fibre may even be damaged during clamping.

The clamping means may be configured to clamp an optical fibre in a first position against the datum plane. The clamping means may be configured to clamp an optical fibre in a second position against the datum plane. The first and second positions may be on opposite sides of the cutting assembly.

The datum plane may comprise a channel or opening therein. The first and second positions may be on opposite sides of the channel or opening.

The compressible surface may, in use, be compressed against the optical fibre by less than diameter of the optical fibre. The compressible surface may be compressed against the optical fibre by less than 125 microns. By compressed against, it is intended that the total compression of the compressible surface from its resting position may be less than 125 microns. In alternative embodiments, the compressible surface may be compressed by less than 100 microns, less than 75 microns, less than 50 microns, less than 40 microns, less than 30 microns, less than 25 microns, or less than 20 microns.

In some embodiments, the compressible surface may be compressed by more than 125 microns, for example, for use with optical fibres with a diameter greater than 125 microns. In some embodiments, the cleaving tool may be configured to exert the majority of the compressive force in the first 125 microns of compression. Other optical fibre diameters are also envisaged, for instance a fibre ribbon formed of fibres of diameter 80 microns. Again, the majority of the compression may occur in a distance less than the fibre diameter. Use of a compressible surface for non-circular fibre is also envisaged.

The compressible surface may have a Shore A hardness of 30 to 95. Optionally, the compressible surface may have a Shore A hardness of 50 to 90, 55 to 85, 60 to 85, 60 to 80, or 65 to 75. Optionally the compressible surface may have a Shore A hardness of 70.

The compressible surface may comprise an elastomer. The elastomer may comprise any one or more of a rubber, EPDM, silicone, polyurethane, or any other suitable elastomer. The compressible surface may comprise a first and second compressible surface. The first and second compressible surface may be the same, or they may be different.

The compressible surface may comprise a coating. The coating may be provided on a rigid support. The rigid support may comprise a metal or plastics material.

The coating may have a thickness of less than 1,000 microns. Optionally, the coating may have a thickness of less than 500 microns, 250 microns, 200 microns, 150 microns, 100 microns, 75 microns, 50 microns, or 25 microns. In some embodiments the coating may have a thickness of less than 10 microns.

The compressible surface may be provided on the at least one clamping portion. In some embodiments, the compressible surface may be provided on the datum plane.

The clamping means may comprise a first clamping portion and a second clamping portion. Each clamping portion may comprise a compressible surface. The first clamping portion may be configured to clamp an optical fibre against the datum plane on a first side of the cutting assembly. The second clamping portion may be configured to clamp an optical fibre against the datum plane on a second side of the cutting assembly.

The first and second clamping portions may clamp the optical fibre independently of each other. The first and second clamping portions may be configured to be movable relative to the datum plane independently of each other.

In an alternative embodiment, the first and second clamping portions may clamp the optical fibre simultaneously or substantially simultaneously. For example, the first and second clamping portions may be connected and/or movable simultaneously or substantially simultaneously relative to the datum plane.

The first and second clamping portions may comprise first and second arms. The first and second arms may be moveable relative to the datum plane. The compressible surface may be provided toward an end of the first and/or second arms. The first and second arms may be hingedly connected to the datum plane. The first and second arms may share a pivot axis. In alternative embodiments, the first and/or second arms may be linearly (or otherwise) moveable relative to the datum plane.

The first and second arms may comprise a bridging portion. The bridging portion may connect the first and second arms. In embodiments wherein the first and second arms are hingedly connected to the datum plane, the bridging portion may be located between the pivot axis and the compressible surfaces.

The cleaving tool may be configured to cleave a ribbon fibre comprising two or more optical fibres. Optionally, the cleaving tool may be configured to cleave a ribbon fibre comprising at least 4, at least 8, at least 12, or at least 16 optical fibres.

The cleaving tool may be configured to cleave the two or more optical fibres simultaneously. Optionally, the cleaving tool may be configured to cleave at least 4, at least 8, at least 12, at least 16 optical fibres, or each of the optical fibres within a ribbon, simultaneously.

The clamping means may be configured to clamp the two or more optical fibres independently of each other. Optionally, the clamping means may be configured to clamp the at least 4, at least 8, at least 12, at least 16 optical fibres, or each of the optical fibres within a ribbon, independently of each other.

The clamping means may be configured to apply an equal, or substantially equal, clamping force to each of the two or more optical fibres. Optionally, the clamping means may be configured to apply an equal or substantially equal clamping force to the at least 4, at least 8, at least 12, at least 16 optical fibres, or to each of the optical fibres within a ribbon.

The cleaving tool may further comprise a comb. The comb may be configured to hold the two or more optical fibres parallel to each other. The comb may be configured to hold the two or more optical fibres parallel to each other in the region on the cutting assembly and/or clamping means.

Optionally, the comb may be configured to hold the at least 4, at least 8, at least 12, at least 16 optical fibres, or to each of the optical fibres within a ribbon parallel to each other. The comb may be configured to prevent splaying of the optical fibres. The comb may be removable.

The comb may comprise two or more guide slots. The guide slots may be configured to receive a single optical fibre. The guide slots may be separated by a tooth. The guide slots may be configured to have a pitch equal to the pitch of a ribbon fibre. The pitch is the separation between the fibres within the ribbon, for example due to sheathing on the optical fibres. The pitch may be 0.25 mm.

The cleaving tool may further comprise a recess for receiving an optical fibre connector, housing or ferrule. The recess may be configured so that an optical fibre extending from the connector, housing or ferrule lies on the datum plane.

Optionally, the connector, housing or ferrule may be cylindrical or substantially cylindrical. The connector, housing or ferrule may comprise a standard optical fibre ferrule and may have an external diameter of 1.25 mm, 2.5 mm, or any other suitable dimension. The connector, housing or ferrule may comprise a central hole with a diameter marginally larger than the optical fibre, through which a fibre or fibres may pass. The fibre(s) may be a stripped fibre. The fibre(s) may be may be glued or retained within the connector, housing or ferrule, for example by an adhesive or any other suitable means. Alternatively, the connector, housing or ferrule may have a quadrilateral (such as rectangular) cross-section, or any other shape. In this series of embodiments, the fibre or fibres may be cleaved at a pre-determined distance from the end of the ferrule.

According to a second aspect of the invention, there is provided a cleaving tool for cleaving ribbon fibres comprising two or more optical fibres, the cleaving tool comprising:
a cutting assembly; and
a clamping means comprising a datum plane and at least one clamping portion, the clamping means configured to clamp two or more of the optical fibres against the datum plane; wherein
the clamping means is configured to apply an equal or substantially equal clamping force to each of the optical fibres within the ribbon fibre.

The clamping means may comprise a compressible surface. In use, the compressible surface may be compressed against the optical fibre. The compressible surface may be compressed by less than the diameter of the optical fibre.

In some embodiments, the compressible surface may be configured to be compressible by a distance greater than the fibre diameter, and configured so that the majority of the compression occurs in a compression distance of less than the fibre diameter.

The clamping means may be configured to apply a clamping force of 0.5 to 20 Newtons to each of the optical fibres. Optionally, the clamping means may be configured to apply a clamping force of 1 to 10 Newtons to each of the clamping positions of the optical fibres. Optionally, the clamping means may be configured to apply a clamping force of at least 2, at least 3, at least 4, at least 5, at least 6, at least 7, at least 8, or at least 9 Newtons to each of the optical fibres, and optionally to each of the clamping positions of the optical fibres.

Optionally, the clamping means may be configured to apply less than 10, less than 8, less than 6, less than 5 or less than 4 Newtons to each of the optical fibres and optionally, to each of the clamping positions of the optical fibres. In some embodiments, the clamping means is configured to apply a clamping force of approximately 4 Newtons to each of the optical fibres, and optionally to each of the clamping positions of the optical fibres. The clamping means may be configured to apply the clamping force to the fibres in more than one location.

The cleaving tool may be configured so that the clamping means and cutting assembly generate a tensile force or stress in the optical fibres during a cleaving action. The cleaving tool may be configured to generate a tensile stress of 0.25 to 10 Newtons. Optionally, the cleaving tool may be configured to generate a tensile stress of at least 0.5, at least 1, or at least 1.5 Newtons. Optionally, the cleaving tool may be configured to generate a tensile stress of less than 5, less than 4, less than 3 or less than 2.5 Newtons. In some embodiments, the cleaving tool is configured to generate a tensile stress of 2 Newtons within the optical fibres during a cleaving action.

In some embodiments, the datum plane may comprise a first support and a second support. The first and second support may be coplanar. Alternatively, the first and second supports may be parallel and offset in a direction perpendicular to the plane of the first and second supports. The first and second supports may be regions or portions of a single unitary body.

In some embodiments, the cleaving tool may comprise a body portion. The datum plane may be integrally formed on a surface of the body portion. The body portion may be a single unitary or monolithic chassis. The present inventors have found that such embodiments minimise manufacturing errors by forming the datum plane (or planes) directly on the body portion rather than by providing separate datum planes which are adjustably connectable to a body portion or chassis. The cutting assembly and/or the clamping means may be connectable to the body portion.

Optionally, the cutting assembly may comprise a blade. The cutting assembly may comprise a blade securing means.

The body may comprise a channel or recess. The channel or recess may comprise a guide surface. The guide surface may be adjacent to the datum plane. The guide surface may be perpendicular to the datum plane. The guide surface may be configured to be perpendicular to the axis of an optical fibre when clamped against the datum plane. The blade securing means may be configured to secure the blade to or against the guide surface.

The blade may comprise a planar body. The blade may be provided with a cutting edge on a first edge of the planar body. The blade may comprises a spine opposite the cutting edge. The blade (for example the planar body of the blade) may comprise a positioning recess or aperture. The positioning recess or aperture may extend into or through the planar body in a direction perpendicular to the plane of the planar body.

The blade securing means may comprise a blade-clamping portion. The blade-clamping portion may be configured to bias the blade against the guide surface. The blade-clamping portion may be configured to apply a force perpendicular to the plane of the blade. Thus the blade can be held in position securely.

The blade-clamping portion may comprise a screw or spring plunger. The blade-clamping portion may have a rounded or curved engaging tip for engaging the blade. The blade-clamping portion may be configured to engage the positioning recess or aperture in the blade. Thus the alignment of the blade (relative to the datum plane) can be set easily and reliably. For example, if the blade is misaligned, the blade-clamping portion may apply an uneven or eccentric force on the positioning recess or aperture, and thus bias the blade into the correct alignment.

The blade securing means may comprise an offset adjustment mechanism. The offset adjustment mechanism may be configured to adjust the position of the blade relative to the datum plane. For example, the offset adjustment mechanism may be configured to adjust the blade position in a direction perpendicular to the plane of the datum plane. The offset adjustment mechanism may be configured to bear upon the spine of the blade. The offset adjustment mechanism may comprise an adjustment screw. The screw may engage a threaded channel in the body portion. The threaded channel may extend into the channel or recess of the body portion. The position of the adjustment screw, relative to the body portion and thus the datum plane, may be adjustable by rotating the adjustment screw. The adjustment screw may comprise a rotatable engagement tip for engaging the blade spine and may comprise a groove therein. The rotatable engagement tip may comprise a seating recess for receiving an edge (e.g. the spine) of the blade.

In some embodiments, the blade securing means comprises both a blade-clamping portion and an offset adjustment mechanism. This provides a simple and secure way to ensure the blade edge is aligned perpendicularly to the axis of an optical fibre to be cut, and at the correct spacing away from (e.g. beneath) the datum plane. The inventors have found that the arrangement can surprisingly provide sufficient accuracy for high quality optical fibre cleaves without requiring adjustable datum planes. Furthermore, with fewer adjustable components, setting up and optimisation of the cleaver is reduced.

In some alternative embodiments, the channel or recess in the body portion may be provided with a guide shelf. The guide shelf may be parallel to, but spaced apart from, the datum plane. The guide shelf may be configured to receive the blade spine. In such embodiments, the offset of the blade edge from the datum plane is not adjustable but the blade is still held accurately and securely.

In a further series of embodiments, the cleaving tool may further comprise a tensioning mechanism. The tensioning mechanism may be configured to increase the tension within the one or more optical fibres during a cleaving operation.

In a third aspect of the invention, there is provided a cleaving tool for cleaving optical fibres, the cleaving tool comprising:

a cutting assembly; and

a clamping means comprising a datum plane and at least one clamping portion configured to clamp one or more optical fibre or fibres against the datum plane; and

a tensioning mechanism configured to increase the tension within the one or more optical fibres during a cleaving operation.

The tensioning mechanism of the first to third aspects of the invention may comprise a tensioning surface or tensioning rod. The tensioning surface or rod may be located at or adjacent to the datum plane. For example, an edge of the tensioning surface or rod may lie in the plane of the datum plane. Alternatively, the tensioning surface or rod may be offset from the datum plane in a direction perpendicular to the datum plane. For example, the tensioning surface or rod may be located beneath the datum plane.

The tensioning mechanism may comprise a first anvil and a second anvil. The first and second anvils may be configured to apply a force to the optical fibre or fibres during a cleaving operation. The first and second anvils may be configured to deflect or bend the optical fibre or fibres away from the datum plane during a cleaving operation. The first anvil and the second anvil may be configured to contact the one or more optical fibres on opposite sides of the tensioning rod. The first and second anvil may be substantially identical. Alternatively, the second anvil may be larger than the first anvil or vice-versa. For example, the second anvil may be wider than the first anvil in the direction of the optical fibre axis. The second anvil may have a greater depth than the first anvil e.g. in the direction perpendicular to the datum plane.

The second anvil may have a greater contact area with the one or more optical fibres than the first anvil. The second anvil may contact the fibre at multiple points. The second anvil may have a polygonal profile, for example, a substantially trapezoidal profile. The second anvil may have a curved profile. The first anvil may similarly have one or more of these features.

By deflecting the optical fibre or fibres away from the datum plane in two locations, the tension within the optical fibre can be greater than by a single deflection caused by a single anvil. Increasing the tension in the fibre is desirable, since it improves the quality of the cleave and cleaved fibre surface. The inventors have found that this configuration is able to increase the tension within the optical fibre without the optical fibre slipping through the clamping means.

In a further series of embodiments, the cleaving tool may contain one or more retaining means. the retaining means may be configured to retain an optical fibre or fibres (and their coatings) on the datum plane. Prevention of movement of the fibres during clamping prevents the loss of tension in the fibres which may otherwise occur if the fibres slipped. Loss of tension is preferably avoided during cleaving because the blade will have difficulty penetrating the fibres to bring about initiation of a cleave and the cleave may be poorly controlled if low tension is present in the fibres during propagation of the crack to form the cleave.

The surface of the datum plane may be coated with an adhesive and/or compliant surface. The adhesive and/or compliant surface may be configured to give a high coefficient of friction between the fibre or fibres and the fibre coatings and the datum plane. The adhesive and/or compliant surface may be configured to prevent slippage of the fibre or fibres. The datum plane may be coated in a polyurethane material. The adhesive and/or compliant surface may be configured to provide compliant adhesive clamping between the fibres and the datum plane. In some embodiments, the datum plane may be coated in a non-polyurethane compliant adhesive coating.

In some embodiments, the surface of the datum plane may be roughened. The roughened surface may be configured to increase the adhesion between the coated optical fibres and the datum plane e.g. to prevent slippage of the fibres through the clamping mechanism. In some embodiments, the datum plane may be roughened by knurling or by providing ridging which is perpendicular to the optic axis of the fibres.

It will be readily understood that dependent or optional features of each aspect of the invention are equally compatible with each other aspect and vice versa.

### BRIEF DESCRIPTION OF THE FIGURES

Exemplary embodiments of the invention are described herein with reference to the accompanying drawings, in which:

FIG. 1 is a perspective view of an optical fibre cleaving tool;

FIG. 2 is a zoomed in view of an optical fibre cleaving tool;

FIG. 3 is a perspective underneath view of a clamping portion;

FIG. 4 is a plan view of an optical fibre cleaving tool;

FIG. 5 is a zoomed in view of a cleaving tool;

FIG. 6 is a cross-section through the line A-A of FIG. 4;

FIGS. 7A and 7B are cross-section diagrams showing a ribbon fibre and clamping means;

FIG. 8 is a perspective view of a cleaving tool;

FIG. 9 is a zoomed in view of the cleaving tool of FIG. 8;

FIG. 10 is a perspective view of an optical fibre cleaving tool;

FIG. 11 is a cross-section through a blade securing means in the plane B-B of FIG. 10;

FIG. 12 is a cross-section through a blade securing means;

FIG. 13 is a perspective view of an optical fibre cleaving tool;

FIG. 14 is a zoomed in perspective view of the cleaving tool of FIG. 13 in use; and

FIG. 15 is a zoomed in view of a cross-section in the plane C-C of FIG. 13.

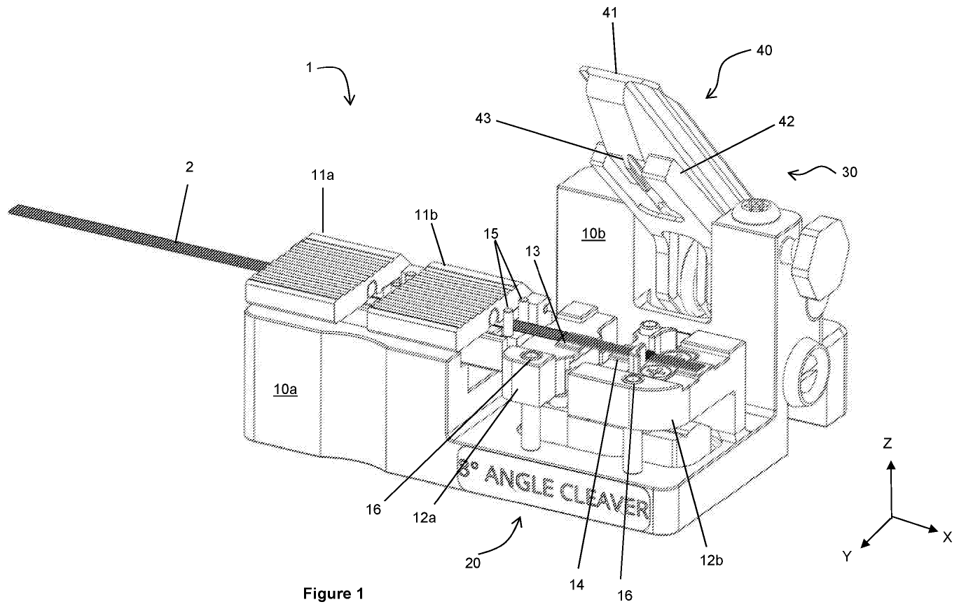

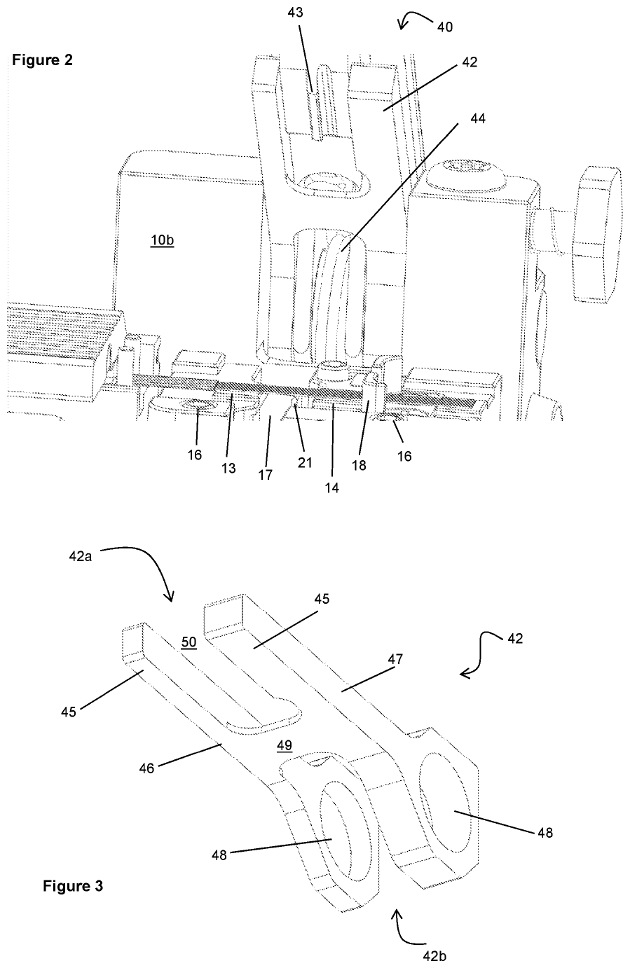

Turning now to FIG. 1, there is shown a cleaving tool 1 and a ribbon fibre 2 positioned within the cleaving tool 1. FIG. 2 is a zoomed in view of the right hand side of the cleaving tool 1 as shown in FIG. 1. The cleaving tool 1 has many features in common and operates on the same principles as the fibre optic cleavers disclosed in the inventor's earlier applications WO/GB98/01598 and GB2501974, descriptions for which will not be repeated in detail herein.

The cleaving tool 1 is formed of a main body portion 10a, which supports the rest of the components of the cleaving tool 1. The cleaving tool 1 has a cutting assembly 20 and a clamping means 30.

On a first side of the cleaving tool 1 there are provided a pair of magnetic clips 11a, 11b which are hinged on their rear edge and can be lifted for loading and unloading of the ribbon fibre 2. In FIG. 1, the clips 11a, 11b are in their retaining position to hold the ribbon fibre 2 in position for a cleaving process to be carried out. Adjacent to the magnetic clips 11a, 11b are a pair of guide rails 15 to guide alignment of the ribbon fibre 2.

On a second side of the cleaving tool, and extending from the main body portion 10, are a pair of supports 12a, 12b. The supports 12a, 12b have upper ends which are provided with support surfaces 13, 14. The support surfaces 13, 14 are substantially coplanar and together form a datum plane. The datum plane acts as both a reference plane and as a support for the optical fibre 2 for the cleaving process. Each of the supports 12a, 12b is independently movable relative to the main body portion 10a by adjustment screws 16. By rotating the adjustment screws 16, the supports 12a, 12b can be moved in the direction Z to compensate for manufacturing tolerances and/or inaccuracies for example. The pair of supports 12a, 12b are separated from each other in the axial direction of the fibre (direction X) thus forming a channel 17 therebetween.

A blade 21 is located within the channel 17 and between the pair of supports 12a, 12b. The sharpened edge of the blade 21 is positioned below the datum plane (i.e. the blade edge is offset from the datum plane in the direction Z) so that, as shown in FIG. 2, the blade edge is adjacent to but not contacting the ribbon fibre 2. The support 12b is provided with a comb 18 for aligning the ribbon fibre 2 on the datum plane.

Adjacent to and extending perpendicularly from the main body portion 10a is a hinge body portion 10b. The hinge body portion 10b is connected to a lever assembly 40, which comprises a lever 41 operable by a user. The lever 41 is hingedly connected to the hinge body portion 10b. The lever assembly 40 further comprises a clamping portion 42 which forms part of the clamping means 30, and an anvil 43 formed on the lower surface of the lever 41. The lever 41 and the clamping portion 42 share a pivot axis and are biased by a spring mechanism 44 into a non-engaged position as shown. The spring mechanism 44 is configured to provide a two-stage resistance. In the first stage, the lever 41 and clamping arm 42 rotate around the pivot axis together until the clamping portion 42 contacts an optical fibre positioned on the datum plane. Subsequently, in a second stage, further rotation of the lever 41 in the same direction is possible by applying a greater force on lever 41. This is typically achieved by using first and second springs within the spring mechanism 44. This second stage moves the anvil 43 through the datum plane and into the channel 17, so deflecting the optical fibre; since the optical fibre is clamped, this acts to extend the fibre and hence to impart a tensioning force to the optical fibre 2. In a cleaving process, the anvil 43 deflects the clamped optical fibre 2 away from the datum plane and into the channel 17, thereby tensioning the fibre, and whereby the tensioned optical fibre 2 is brought into contact with the blade 21. The blade 21 thus scratches the optical fibre 2—the scratch then propagates through the optical fibre due to the tension therein to cleave the fibre in two.

Thus, as described above, the cutting assembly 20 is formed of a blade 21 and an anvil 43. In turn, the clamping means comprises a datum plane and a clamping portion 42.

Turning now to FIG. 3, the clamping portion 42 will be described. The clamping portion 42 is provided with a compressible surface 45 on a lower side thereof i.e. on the surface facing the datum plane. The compressible surface 45 is an elastomeric coating. In the embodiment shown in FIG. 3, the clamping portion 42 is a rigid support on which the compressible surface 45 is provided. The clamping portion 42 is approximately H-shaped, and has an elongate first and second arm 46, 47. The first and second arm 46, 47 have a first end 42a and a pivot end 42b provided with hinge holes 38 for connecting to the hinge body portion 10b by an axle or pivot (not shown). A bridging portion 49 extends between the first and second arm 46, 47. The bridging portion 49 is located between the first end 42a and the pivot end 42b. The bridging portion 49 is located approximately half way along the length of the first and second arms 46, 47. The bridging portion 49 provides a simple way of ensuring the movement of the first and second arm 46, 47 is simultaneous to thereby clamp the optical fibre 2 in two positions simultaneously. Furthermore, because of the thinness of the bridging portion 49, it is able to flex in the Z direction and thus ensures that the optical fibre 2 is clamped in two positions simultaneously and ensures that tension is reliably maintained in the fibre in order to achieve a high quality cleave.

Between the first and second arms 46, 47 is a slot 50, which has a width similar to the width of the channel 17. As shown in FIG. 2, the slot 50 is aligned with the anvil 43, so that the anvil 43 can project between the first and second arms 46, 47. The slot 50 is also aligned with the channel 17 and the datum plane so as to clamp an optical fibre against the datum plane on either side of the channel 17.

The compressible surface 45 is formed by a compressible coating, such as an elastomeric coating. The compressible surface 45 is provided on the first and second arms 46, 47 in a region aligned with the datum plane, where the arms will contact the optical fibre in use. The compressible surface 45 can be any suitable material with suitable material properties, for example a rubber, EPDM, silicone, polyurethane, or any other suitable elastomer. It is important that the compressible surface 45 has a degree of compressibility that allows it to partially but not fully conform to the surface of the optical fibres and the datum plane. The compressible coating has a thickness of approximately 150 microns.

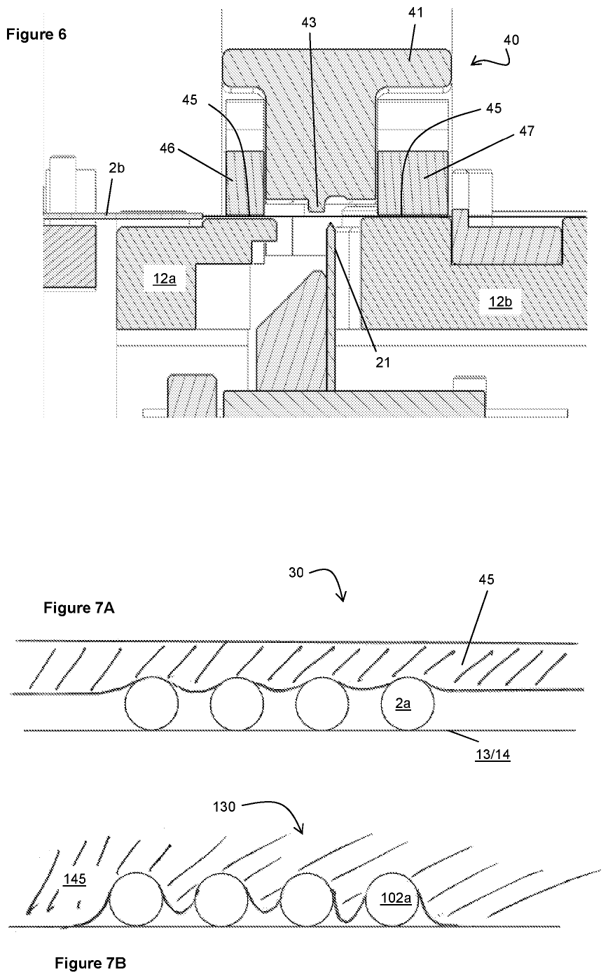

It is the intention of the present invention that the clamping portion 42 immobilises the optical fibres 2. As shown in FIG. 6, typically it will be the stripped regions 2a of the optical fibres 2 which are immobilised against the datum plane.

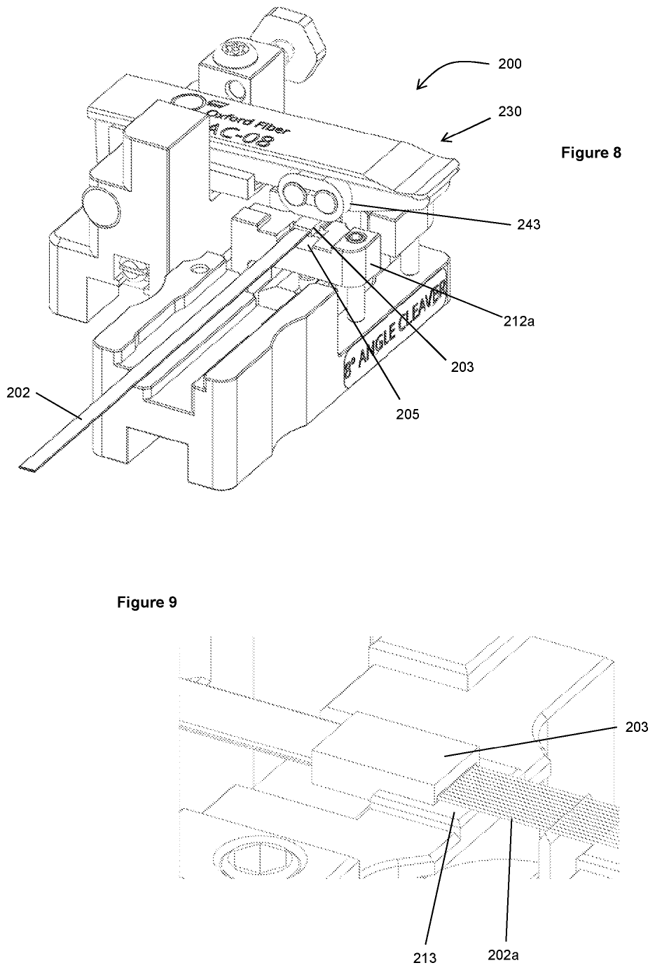

In an alternative embodiment, it is possible to clamp the unstripped region 2b of the ribbon fibre 2, the clamping force being transmitted to the fibres 2 via the coating which is present around the ribbon fibre. Clips 11a and 11b in FIG. 1 are an example of such a clamp which clamp the fibres 2 through their coating. Alternatively, the fibre 2 may be secured in a housing or other secure attachment to the fibres (for example as shown in FIGS. 8 and 9, but not limited thereto). In such an embodiment, with the fibres immobilised within a housing or other secure attachment, the fibres may be clamped directly against the datum plane in only one position. The housing or other secure attachment can be retained adjacent to the datum plane so that the optical fibres are immobilised against the datum plane in order to be cleaved.

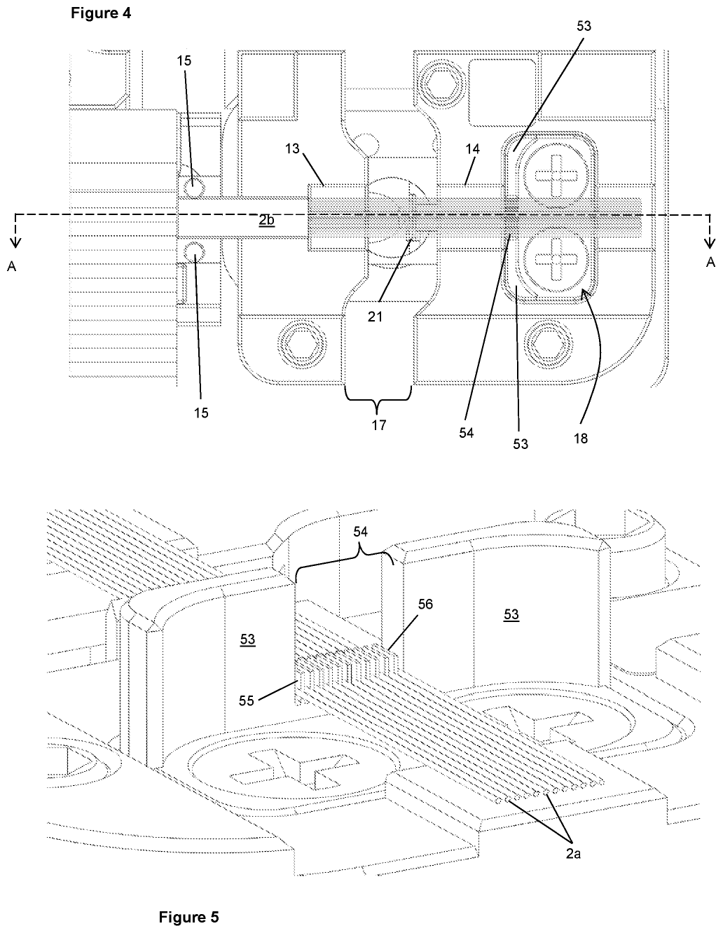

Turning now to FIG. 4 there is shown the cleaving tool in a plan view, with the lever assembly omitted.

As best shown in FIG. 4, the comb 18 is provided adjacent to the support surface 14 so as to retain the ribbon fibre 2 on the datum plane. The comb 18 is formed by a pair of upright walls 53 separated by a central aperture 54. The upright walls 53 guide the ribbon fibre 2 in position. The central aperture is provided with a series of guide slots 55 and teeth 56, as shown in FIG. 5. In order to cleave the ribbon fibre 2, the sheathing of the fibre is stripped and each of the stripped optical fibres 2a is aligned within the guide slots 55. The pitch of the guide slots, i.e. the distance between neighbouring guide slots 55 is set to match the pitch between the optical fibres 2a within the ribbon fibre 2. Thus, between the sheathed section 2b of the ribbon fibre and the comb 18, the optical fibres 2a all extend parallel to each other. The individual optical fibres 2a can be located in the guide slots 55 quite simply by inserting the stripped optical fibres 2a immediately adjacent to the sheathed portion 2b, into the central aperture 54 from above. Since the sheathing around the optical fibres maintains their pitch, the alignment of the optical fibres 2a into the guide slots 55 is achieved without multiple fibres being located within a single guide slot 55. The ribbon fibre 2 can be retracted or pulled through the comb 18 and clamped under the magnetic clips 11a, 11b. As shown in FIGS. 4 and 5, this arrangement is very effective at retaining the optical fibres parallel to each other in the region of the clamping means and cutting assembly. In FIG. 4, the optical fibres are shown immediately above the blade 21 prior to a cleaving process being carried out.

Turning now to FIG. 6, there is shown a cross-section through the cleaving tool 1 in the plane A-A of FIG. 4, but with the lever assembly 40 shown. FIG. 6 shows the cleaving tool part way through a cleaving process. The lever 41 has been depressed by a user toward the datum plane.

The first and second arms 46, 47 have been moved down so that the compressible surface 45 contacts the upper edges of the stripped optical fibres 2a. In order to effect near simultaneous clamping of the fibres at the first and second positions, the height of the datum planes 12a, 12b can be adjusted relative to each other by using screws 16. A greater force must then be applied to the lever 41 to overcome the spring assembly (not shown). The spring assembly is configured to ensure that a sufficient amount of force is applied to the optical fibres 2a to hold them tightly in position. Once the force is reached, the lever 41 moves downwards toward the datum plane, thus bringing the anvil 43 into contact with the optical fibres. Further movement presses the fibres 2a down, thereby deflecting them away from the datum plane as described in the inventor's earlier applications WO/GB98/01598 and GB2501974 thereby applying a tensioning force to the fibres and contacting them with the blade 21. The blade 21 scratches the fibres 2a to instigate a cleave with the desired properties

Turning now to FIGS. 7A and 7B, the compressible surface 45 and its advantages over the prior art will now be described in further detail. FIG. 7A is a not-to-scale exemplary diagram showing the optical fibres 2a clamped within the clamping means 30. In comparison, FIG. 7B is a not-to-scale diagram of a prior art clamping means 130.

The compressible surface 45 is compressed against each of the optical fibres 2a, which lie on the datum plane formed by the support surfaces 13/14. Because the compressible surface 45 compresses around the optical fibres 2a by less than the thickness of the optical fibres 2a, the compressive force experienced by each optical fibre is the same. Furthermore, the optical fibres 2a are all securely retained in position on the datum plane, and slippage of the optical fibres 2a is minimised or prevented. The amount of compression of the compressible surface 45 can be modified by the selecting hardness and/or the thickness of the compressible surface 45.

The present inventors have discovered that a much larger clamping force is required to effectively cleave a ribbon fibre compared to a single optical fibre. To obtain an effective cleave in all of the optical fibres within the ribbon, the clamping force must be sufficient to adequately clamp each fibre in the ribbon. Typically, 1N to 2N of extension stress must be applied to a single 125 micron diameter silica optical fibre in order to propagate a cleave when the fibre is scratched without creating unacceptable defects.

An existing clamping means may have a rubber clamping portion with a co-efficient of friction of approximately 0.5, and require a clamping force in the region of 4N. For a ribbon fibre comprising 12 optical fibres, this therefore requires a clamping force of 48N, and since the fibre must be clamped on either side of the cutting assembly, the clamping force may be approximately 96N. If the clamping force is insufficient, the fibres will slip through the clamps to thereby reduce the tension within the fibre. The fibres may still cleave but the cleaved surface is liable to be excessively curved which can negatively affect coupling of the light into and out of the optical fibre.

In FIG. 7B there is a clamping means 130 as intended for single optical fibres but clamping multiple optical fibres. Such clamping means typically have thick rubber portions 145 for clamping the optical fibre 102a against a datum plane. When subjected to the increased force required to clamp multiple optical fibres, these thick and soft rubber portions 145 deform around the optical fibres 102a. In some positions, the rubber portions will contact the datum plane adjacent to the optical fibres, and extend between the fibres. This can apply an undesirable rotational force on the optical fibres as well as reducing the downward clamping force applied to the optical fibres.

This causes a number of issues. For example, the optical fibres 102a are not all held equally securely, since some of the clamping pressure may be applied directly to the datum plane rather than through the optical fibre. As a result, some of the fibres are liable to slip or roll during a cleaving process, which can cause individual optical fibres to be cleaved to a different length to those immediately adjacent to it. Similarly, slipping of a fibre can reduce the tension within the fibre, and thus the scratch in the optical fibre does not propagate correctly causing a high amount of defects such as poor cleave angles and/or excessively large starter cracks on the cleaved surface and/or damage to the sharp blade. Because the cleave must be highly precise, such minor errors can cause high levels of signal loss once joined to a further optical fibre or connector, thus rendering the cleave useless and increasing costs due to wastage. Typically, the thickness and softness of the known prior art rubber portions 145 is desirable for use when clamping single optical fibres, since the rubber portion would be subject to much lower clamping forces and would be able to partially encapsulate the single optical fibre and effectively retain it in position. The present inventors have discovered that by reducing the compression of the compressible surface, a far more precise and reliable angled cleave may be achieved.

It will be understood that certain variant to the embodiments described herein can be made without diverging from the scope of the invention.

As set out above, the invention has been described within the context of performing angled cleaves to a ribbon fibre. The invention is equally applicable to performing perpendicular cleaves by using a different cutting assembly comprising an anvil configured to contact the optical fibre at two positions, deflect the fibre away from the datum plane, and a blade configured to scratch the optical fibre between the two positions where the anvil contacts the optical fibre.

Turning now to FIGS. 8 and 9, there is shown a further cleaving tool 200 for optical fibres. The cleaving tool 200 is substantially the same as the cleaving tool 1, except the clamping means 230 has been configured to clamp a ribbon fibre which is already attached to a housing 203, in order for it to then be cleaved.

The ribbon fibre 202 extends through a housing 203. The housing 203 is located within a recess 205 provided in the support 212a. The recess 203 is configured so that the housing sits adjacent to the support surface 213. The stripped optical fibres 202a thus extend from the housing and lie on or close to the datum plane formed partially by the support surface 213. The clamping portion 243 is either supplemented by a further arm (not shown) to clamp the optical fibres directly as described previously, or alternatively, the clamping portion 243 can be shaped so as to clamp both the housing 203 and the optical fibres 202a simultaneously. In some embodiments (not shown), the clamping means 230 may be modified so that the relative heights of the arms are arranged so that the clamping H clamps both the top of the housing 203 and the (stripped) fibre 202a substantially simultaneously. The ribbon fibre is thus cleaved at a predetermined distance from the end of the housing and this assembly can conveniently be used to secure the housing and its protruding cleaved fibres for attachment to an opto-electronic device, other fibre connector or similar.

As described above, the fibres 202 are clamped against the datum plane for the purpose of immobilising the fibres 202 so that the fibres 202 are tensioned by the anvil deflecting the fibres 202 from the datum plane. Additionally or alternatively, the fibres 202 may also be immobilised in other ways.

For example, the fibres 202 may be fixed to the housing 203 (e.g. by an adhesive) and the housing 203 placed adjacent the datum plane, in the position shown in FIGS. 8 and 9. The housing 203 can be clamped to the datum plane, the fibres deflected in order to tension them, and then cleaved. In some embodiments, it is not necessary to actively clamp the housing 203 directly. The housing 203 with its connected fibres may be pushed or pulled against a stop portion configured in the recess and/or support 212a, either by directly applying a force to the housing or by the tensioning of the fibres. When the fibres 202a are depressed by the anvil 243, the housing 203 can be pulled against the stop and thus the housing is immobilised. Thus, the fibres 202 are tensioned by the motion of the anvil and will cleave when they come in to contact with the blade.

Alternatively, the fibre(s) 202 may pass through the housing 203 without being glued or otherwise fixed to the housing. In this embodiment the fibre(s) may be immobilised by clamping their coating in an external clamp, such as shown in FIG. 1 using clamps 11a, 11b, or the fibres may be otherwise immobilised. The stripped portion of the fibre 202a is clamped on surface 14 so that tension may be applied to the fibre and so cleaving may be carried out.

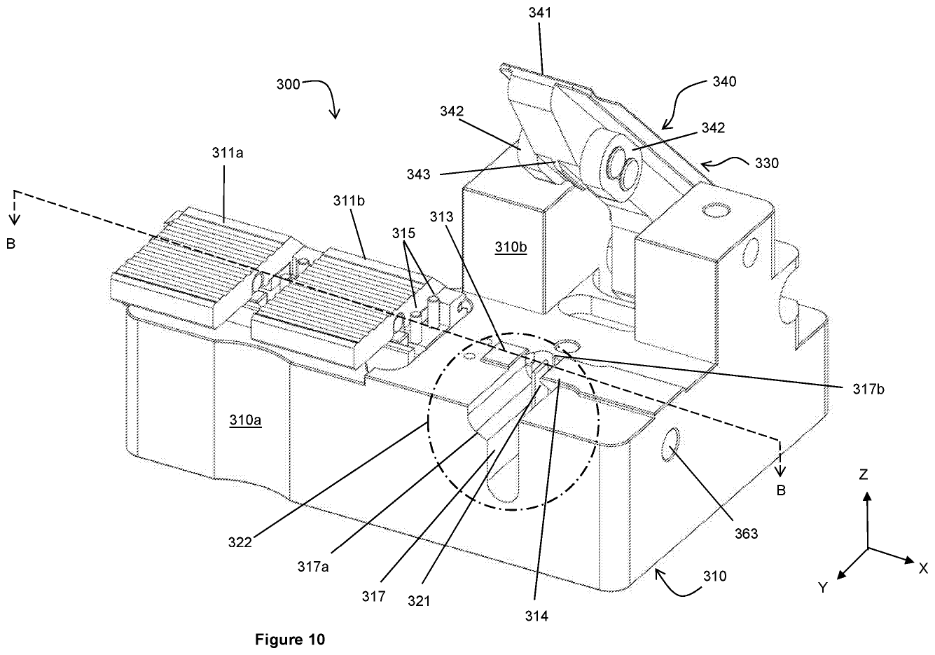

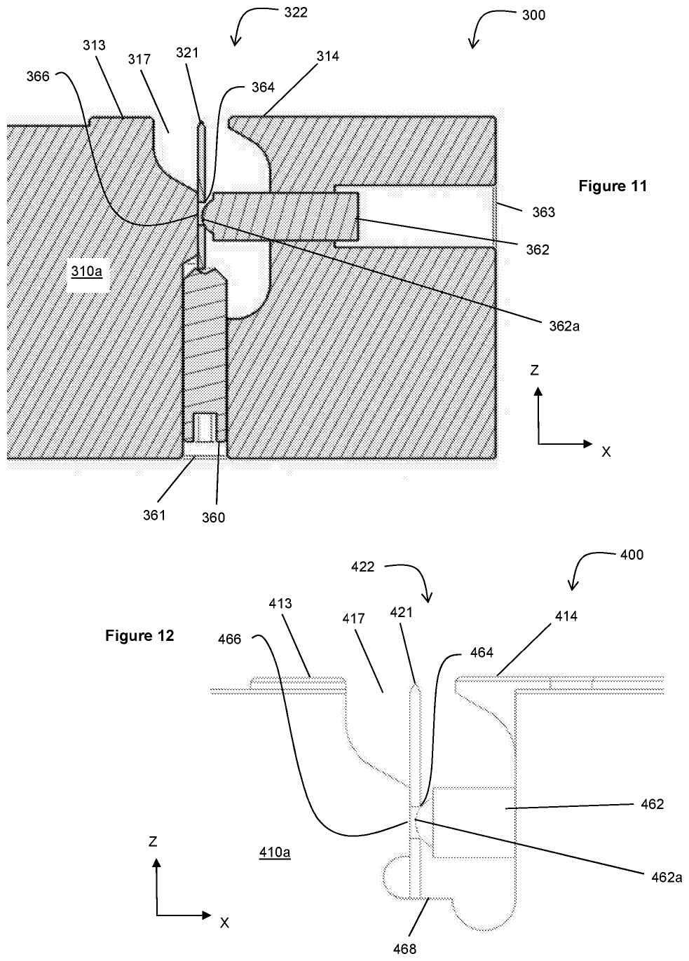

Turning to FIGS. 10 and 11, there is shown a further optical fibre cleaving tool 300. The cleaving tool 300 has many features in common with and operates on the same principles as optical fibre cleaving tools 1 and 200, and description of like parts will not be repeated.

The cleaving tool 300 is formed of a body portion 310, which supports the rest of the components of the cleaving tool 300, such as clamping means 330. The body portion 310 is a single, unitary element with two subsections: a main body portion 310a and a hinge body portion 310b. In alternative embodiments (not shown), the body portion comprises multiple components, but with a blade support and datum plane formed from a single integral component.

The hinge body portion 310b has a lever assembly 340 and clamping means 330 as previously described with reference to the embodiment of FIG. 8.

The clamping portions 342 comprise a flexible material in the form of a ring. The clamping portions 342 can be any suitable material with suitable material properties, for example a rubber, EPDM, silicone, polyurethane, or any other suitable elastomer. It is important that the rings have a degree of compressibility that allow them to partially but not fully conform to the surface of the optical fibres and the datum plane. Preferably, the rings are formed of polyurethane. Polyurethane has a better temperature tolerance than, for example, EPDM and therefore there has less variation of compressibility at different temperatures.

The main body portion 310a is provided with a pair of magnetic clips 311a and 311b. These operate in the same manner as magnetic clips 11a and 11b. Adjacent to the magnetic clips 311a and 311b are a pair of guide rails 315 to guide alignment of a ribbon fibre to be provided. In alternative embodiments (not shown) the clips may be mechanical rather than magnetic. In some embodiments (not shown) the ribbon fibre may be located in a shallow ribbon channel to achieve alignment. In such embodiments, the guide rails may be integrally formed as part of the side walls of the ribbon channel.

The main body portion 310a, has two support surfaces 313, 314. The support surfaces 313, 314 are substantially parallel and may be coplanar or offset from each other and together form a datum plane, similarly to support surfaces 13, 14. The support surfaces 313, 314 are separated from each other in the axial direction of the fibre by a recess or channel 317 formed in the main body portion 310a. The axial direction of the fibre is henceforth termed direction X. The support surfaces 313, 314 are located directly on the upper surface of main body portion 310a. By upper surface it is meant that the surface is uppermost with respect to the direction Z.

The channel 317 has an open end 317a and a closed end 317b. The open end 317a is located on a face of the main body portion 310a which directly opposes the hinge body portion 310b in direction Y. The channel 317 extends into the main body portion 310a in the direction Y and terminates with the closed end 317b which is located within the main body portion 310a. The channel 317 also has a depth in the direction Z and is open on the upper surface of the main body portion 310a and closed at the opposing end. In some embodiments (not shown) the open end 317a may also be closed via means of a plug or other means.

The body 310 has a blade securing means, which will be described in more detail below with reference to FIG. 11. A blade 321 is located within the channel 317. The blade 321 is substantially rectangular and has a cutting edge sharpened relative to the other edges. The blade has a spine opposite the cutting edge. The length of the blade corresponds to the length of the cutting edge and the height of the blade is defined as the distance between the cutting edge and spine. The blade 321 has a positioning recess or aperture 364 extending through the blade. In alternative embodiments the positioning recess or aperture extends only partially through the thickness of the blade. The cutting edge of the blade 321 is positioned below the datum plane.

Turning to FIG. 11, the blade securing means within area 322 will now be described. The distance between the datum plane and the blade cutting edge (in the direction Z) will be referred to herein as the offset. The blade securing means has an offset adjustment mechanism 360; a blade securing portion 362; and a guide surface 366. The blade securing means is configured to retain the blade in position against the guide surface 366, and in some embodiments, against the closed end 317b of the channel 317. Thus, the blade is retained in the X and Y directions.

The offset adjustment mechanism 360 is configured to move the blade edge toward or away from the datum plane. In the pictured embodiment, the offset adjustment mechanism 360 comprises a threaded screw provided within a first aperture 361. The first aperture 361 has an open end on the lower surface of the main body portion 310a and extends along the Z direction to meet the bottom of channel 317.

The blade securing portion 362 comprises a threaded screw located within a second aperture 363. This second aperture 363 is correspondingly threaded and has an opening on an outer surface of the main body portion 310a. The second aperture 363 extends in the direction X to the channel 317. The blade securing portion 362 has an engaging end 362a that, when the blade securing portion 362 is tightened, will engage with positioning recess 364 in the blade 321. The engaging end 362a is curved in shape. In other embodiments (not shown) the engaging end may be conical or some other shape.

The engaging end 362a of the blade securing portion 362 may be provided by a ball-bearing. The ball-bearing may be biased outwards from the end of the screw by, for example, a spring internal to the blade securing portion 362. This biased ball-bearing improves the function by providing a continuous force on the positioning recess 364, resulting in the lateral pressure as described below. This force will continue to be present even when the blade securing portion 362 is no longer being tightened. In addition, in some embodiments the biased ball bearing can be configured to prevent the blade securing portion 362 from being tightened too much by the user and thus potentially damaging the blade 321.

The guide surface 366 is a flat surface located on a wall of the channel 317 and is opposite to the second aperture 363. The guide surface 366 is perpendicular to direction X (e.g. the axis of the optical fibres during a cleaving operation. The guide surface 366 is substantially located directly above the first aperture 361 and the offset adjustment mechanism 360. The guide surface 366 provides alignment in the plane ZY.

Similarly, the closed end 317b of the channel 317 provides alignment in the plane ZX and thus provides a further surface against which the blade can be biased to ensure alignment, prevent rotation and secure the blade in position.

During calibration, the user places the blade 321 within the channel 317 with the spine of the blade 321 seated on the offset adjustment mechanism 360. The offset adjustment mechanism 360 can be accessed from the underside of cleaving tool 300 via the first aperture 361. The user can screw and unscrew the offset adjustment mechanism 360 to adjust the height of the blade so that it is positioned correctly with respect to the datum surface and thus is at a suitable offset for cleaving an optical fibre or fibres.

Once the offset adjustment mechanism 360 and blade 321 are at a suitable offset, the blade securing portion 362 can be used to secure the blade 321 in position. The blade securing portion 362 can be accessed from one side of the cleaving tool 300 via the second aperture 363. When tightened, the blade securing portion 362 clamps the blade between the engaging end 362a and the guide surface 366. The blade is therefore secured in place and prevented from lateral or vertical motion when in use, until the blade securing portion 362 is loosened.

It will be appreciated that, beyond simply securing the blade 321 in position, this configuration of the blade securing means provides a number of benefits to the user. Once the offset adjustment mechanism 360 has been adjusted to a suitable offset, the blade securing portion 362 is tightened and the engaging end 362a will contact an edge of the positioning recess 364. This will result in an imbalanced force acting on the edge of the positioning recess 364. This force will exhibit a lateral and/or eccentric pressure on the edge of the positioning recess 364 (i.e. radially outwards from the centre of the positioning recess 364). As the blade securing portion 362 is tightened further, this lateral pressure will push the blade into position and bias the blade 321 toward the closed end 317b of the channel 317 which provides a hard stop. A self-locating functionality is thus achieved.

When the blade 321 is in the fully secured position the innermost lateral edge of the blade (that is, the lateral edge of the blade nearest to the closed end 317b of the channel 317) abuts the closed end 317b of the channel 317. This further improves the stability of the blade when it is secured since it is being held in place by the blade offset adjustment means 360, the blade securing portion 362, the guide surface 266 and also the closed end 317b. In some embodiments, this stability may be further improved by providing a seating recess on the uppermost end of the offset adjustment mechanism 360. The bottom edge of the blade 321 may be seated in this recess, thus ensuring the blade 321 is more resistant to lateral motion.

In the fully secured position, it need not be the case that the bottom of the blade 321 sits on the blade height adjustment screw 360 because the blade is held both laterally and vertically through the combination of the blade securing portion 362, the positioning recess 364 and the guide surface 366. This means that the blade can be precisely located as required for cleaving in a manner which is much easier for the user.

The unitary construction of body 310 means that fewer discrete components are present in cleaving tool 300. In particular, supports 12a, 12b are no longer required, and the cutting assembly 20 is substantially integrated with the body 310. Thus the cleaving tool 300 is simpler and easier and cheaper to manufacture, assemble, and easier to operate than existing similar products. Furthermore, fewer parts improves the accuracy of the construction, since there are fewer manufacturing tolerances being compounded and requiring mitigation. Perpendicularity between the blade edge and the optic axis of the fibres is required to ensure that all of the fibres are cleaved to the same length. The use of a blade without supporting parts means that this perpendicularity can be achieved by mounting the blade perpendicularly to the optical fibre axis in the cleaver—provided that the blade is manufactured with its cutting edge exactly parallel with the length and spine of the blade. This can be achieved by accurate grinding and polishing of the blade. The cleaving tool 300 can therefore operate at the same or better level of precision and accuracy than a cleaving tool that has many separate components, whilst being simpler to manufacture and set up.

Turning now to FIG. 12, an alternative configuration for the blade securing means 422 is depicted for a cleaving tool 400. This embodiment is substantially the same as that depicted in FIGS. 10 and 11 and like numerals correspond with like features. However, in the FIG. 12 embodiment, the offset adjustment means 360 has been replaced by a guide shelf 468. The blade 421 is placed directly onto guide shelf 468 and requires no further offset adjustment. The blade securing portion 462 is then tightened to engage the engaging end 462a with the positioning recess 464 to clamp the blade against the guide surface 466 and closed end 317b and achieve the aforementioned self-locating functionality.

In cleaving tools already known in the art, it is considered that a highly adjustable blade position is a desirable feature. It is therefore contrary to common practice to provide fewer adjustable parts for adjusting the blade location. The inventors have found that by providing a unitary main body portion 310a, 410a it is still possible to create a cleaving tool 300, 400 which remains effective, and requires little or no adjustment or set up on the part of the user. This results in improved efficiency in operating the cleaver while not sacrificing the cleave quality, which may be desirable when the cleaver is being operated by field engineers.

In FIG. 12, the configuration of the guide shelf 468 is shown with additional cutouts such as required for conventional manufacturing (e.g. milling of the body 410). It is envisaged that alternative configurations and structures would provide the same advantages. For example, the guide shelf 468 may be the bottom of channel 417. It is also recognised that blades may be manufactured to slightly differing heights (i.e. distance between cutting edge and spine). In order to allow all blades to be used in cleavers, the blades may be split in to different groups, each group containing blades of largely the same height. Cleaving tools with slightly different heights of guide shelf may be paired with blades of different heights, i.e. deep blades may be installed in cleaving tools with lower shelf heights and shallower blades may be installed in cleaving tools with higher shelf heights to ensure that all cleaving tools had similar offsets between the blade edge and the datum plane.

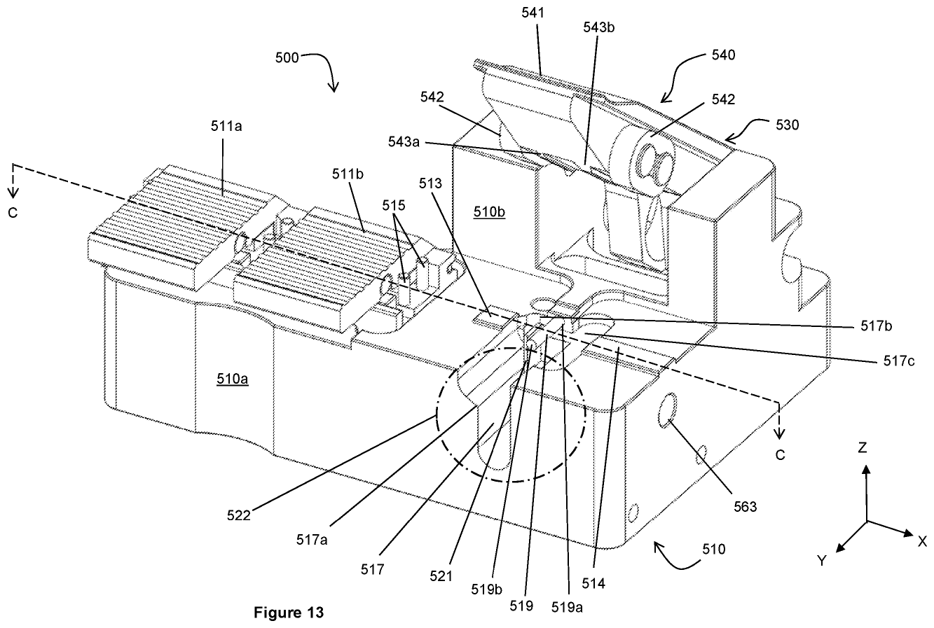

Turning now to FIGS. 13 to 15, there is shown a further embodiment of an optical fibre cleaving tool 500. The cleaving tool 500 shares many features with the previously described optical fibre cleaving tools and descriptions will not be repeated herein. The optical fibre cleaving tool 500 comprises a tensioning mechanism. The tensioning mechanism has a cylindrical tensioning rod 519, with a first end 519a of the tensioning rod secured to the closed end 517b of the channel 517. The tensioning rod 519 extends away from the closed end 517b towards the open end 517a of the channel 517, and terminates at second end 519b. The distance from 517b to 519b is greater than or equal to the distance 517b to the further end of the cutting edge of the blade 521. In this way, the tensioning rod 519 extends perpendicularly to the direction of the fibre (i.e. the tensioning rod extends in the Y direction). As shown in FIG. 15, the tensioning rod 519 is positioned in the Z direction such that the uppermost point on the outer surface of the tensioning rod 519 is located above the cutting edge of blade 521.

The tensioning mechanism further comprises a first anvil 543a and a second anvil 543b. These are formed on the lower surface of lever 541 and are spaced from each other. Furthermore, the first and second anvils 543a, 543b are located either side of the tensioning rod 519. First anvil 543a is located closer to support surface 513 and slightly offset from the cutting edge of blade 521. Second anvil 543b is located closer to support surface 514. This means that, when lever 541 is rotated to move the anvils 543a and 543b towards an optical ribbon fibre (i.e. towards a closed position), the tensioning rod 519 is located between the anvils 543a and 543b. Second anvil 543b is larger than first anvil 543a i.e. the second anvil 543b has both a greater lateral width (in the direction X) and a greater depth (in the direction Z) than first anvil 543a.

The optical fibre cleaving tool 500 further comprises a channel recess 517c. Channel recess 517c is located adjacent to (e.g. directly below) second anvil 543b, enabling the second anvil 543b to travel into channel recess 517c when the lever 541 is rotated towards the closed position.

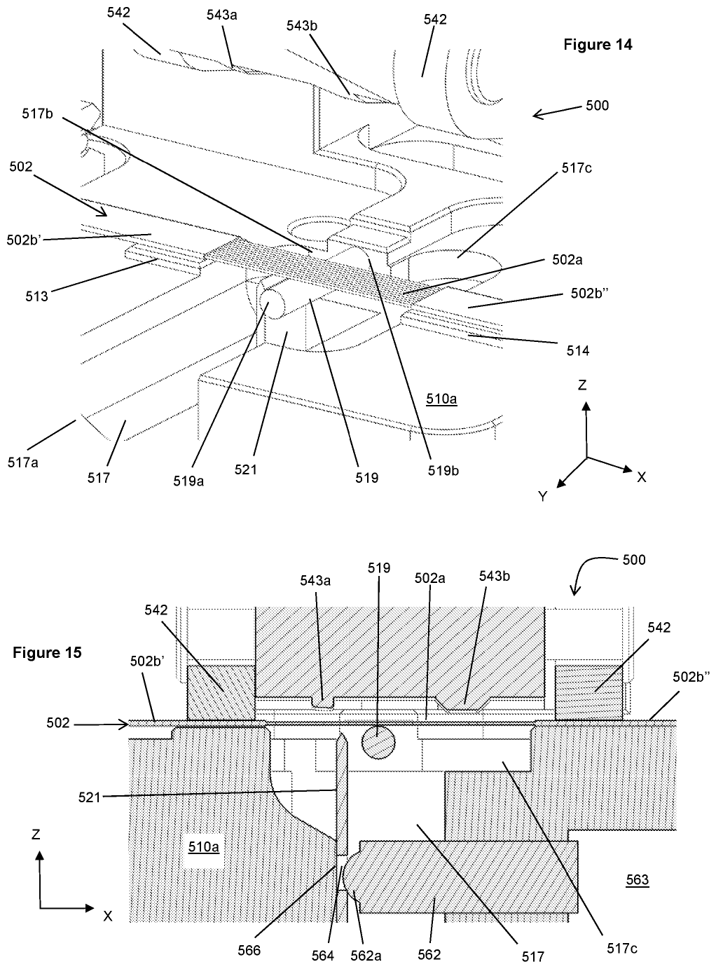

With reference to FIGS. 14 and 15, the use of cleaving tool 500 will be described. In use, an optical fibre, such as a ribbon fibre 502 is secured in cleaving tool 500 as described above in relation to previous embodiments. An appropriate position for optical fibre ribbon 502 prior to cleaving is seen clearly in FIG. 14. The optical fibre ribbon 502 has been “window-stripped” i.e. the outer coating of the optical fibre has been removed in an intermediate portion of the fibre, while retaining the outer coating on either side of the “window” as will be described in detail below. The window stripping technique has been found to be effective by the inventors, but in some cases, the user may wish to use the tool without this technique.

The operational use of lever 541 may be described in three stages. In the first stage, the lever 541 is rotated about its pivot axis until clamping portions 542 are brought into contact with optical fibre ribbon 502 and clamp the optical fibre ribbon 502 against support surfaces 513 and 514. In the second stage, the lever 541 is further rotated in the same direction compressing the clamping portions 542 and bringing second anvil 543b into contact with optical fibre ribbon 502. In the third stage, the lever 541 is rotated in the same direction further still, bringing first anvil 543a into contact with optical fibre ribbon 502.

During the second stage, second anvil 543b contacts the optical fibre ribbon 502 before the first anvil 543a. This is because the second anvil 543b has a greater depth (i.e. it protrudes further from lever 541) than the first anvil 543a. As the lever 541 is rotated further, second anvil 543b presses the fibres downwards into channel recess 517c, thereby deflecting them away from the datum plane and applying a first tensioning force to the fibres. Prior to the contacting of first anvil 543a with optical fibre ribbon 502, the presence of tensioning rod 519 prevents second anvil 543b from pushing the optical fibre ribbon 502 into contact with blade 521. The first tensioning force provided by second anvil 543b and the tensioning rod 519 therefore does not cause the fibres to be scratched or cleaved.

During the third stage, both second anvil 543b and first anvil 543a are in contact with optical fibre ribbon 502. As the lever 541 is rotated further, first anvil 543a presses the fibres downwards into channel 517, thereby deflecting them away from the datum plane and applying a second deflecting force to the fibres. This second deflecting force directs the fibres into contact with blade 521. The blade 521 scratches the fibres to instigate a cleave.

It will be appreciated that several advantages are afforded by the aforementioned configuration of tensioning mechanism. In the previous embodiments, the fibres are clamped at two locations and deflected by the anvil. The deflection of the fibre causes an increase in tension on the outside of the bend, and compression of the fibre on the inside of the bend. This stress profile can cause the cleave to propagate in an uneven manner, known as roll-off. In the embodiment shown in FIGS. 14 and 15, the deflection by the second anvil creates an even tension in the fibre immediately adjacent to the first anvil. Thus, when the first anvil subsequently deflects the fibre, the compression forces acting on the inside of the bend act against the tension already applied. The net result is a reduction in compressed fibre (e.g. by cross-sectional area and/or net force applied) and thus a reduction in roll-off and improved cleaving results.

As described above, second anvil 543b is larger than first anvil 543a in both width and depth. The greater width of second anvil 543b enables the second anvil 543b to have a greater contact area with the fibres. That is to say that the second anvil 543b will contact the fibres at multiple points, or along a large surface area. This is advantageous because it provides a greater tension in the fibres as the lever 541 is rotated.

In FIGS. 13 to 15, the second anvil 543b is depicted as a protrusion having a substantially trapezoidal profile. However, it will be appreciated that other shaped anvils are contemplated within the scope of the invention. The second anvil 543b may be a protrusion having a profile that is, for example, substantially: triangular rectangular, ellipsoidal, cylindrical, hemi-spherical or otherwise curved. The curved profile of the second anvil 543b may have a curve which is the same as the curve of an optical fibre under tension. The first anvil 543a may similarly be of a different shape to that depicted.

Similarly, the tensioning rod 519 is depicted as a cylindrical rod. Other shapes of the tensioning rod 519 may be used. The tensioning rod 519 may have a non-circular cross-section). For example, tensioning mechanism 519 may have a triangular, rectangular or other polygonal cross-section. The tensioning mechanism 519 may have an elliptic or otherwise rounded face. The tensioning mechanism 519 alternatively may not be a rod at all, for example, the tensioning mechanism 519 may be the upper ledge of a wall or surface.

Furthermore, channel recess 517c need not be of the form depicted in FIGS. 13 to 15. For example, channel recess 517c may instead just be an extension in the direction X of the channel 517 (i.e. the channel recess 517c is the same depth as channel 517).

The efficacy of the above tensioning mechanism is further improved through the use of a window-stripped optical fibre ribbon 502, as depicted in FIGS. 14 and 15. By “window-stripped”it is meant that the outer sheathing of optical fibre ribbon 502 has been removed across a length of the optical fibre ribbon 502 which is not located at the end of the ribbon 502. In other words, the end of the ribbon 502 is still sheathed and a stripped portion 502a exists further along the ribbon 502. In this way, three portions of the ribbon 502 are obtained: a first unstripped portion 502b′; a stripped portion 502a (the “window”); and a second gloved portion 502b″. The gloved portion of sheathing is conveniently formed from sheathing which has been translated along the axis of the fibre, for instance by thermally softening a portion of the original sheathing using a conventional thermal stripping tool, sliding the glove along the optical fibres and then allowing the gloved portion of the coating to cool, reforming a sheath around the optical fibres. This is in contrast to the usual end-stripped ribbons often used in which the end of the ribbons are stripped to leave the majority of the ribbon unstripped and a small portion stripped at the end of the ribbon.

In use, the window-stripped optical fibre ribbon 502 is placed into the cleaving tool 500 with first unstripped portion 502b′ resting on support surface 514 and second unstripped portion 502b″ resting on support surface 513, leaving stripped portion 502a positioned across channel 317 and channel recess 317c. As seen in FIG. 15, the stripped portion 502a rests on the tensioning rod 519 and will be contacted by first and second anvils 543a, 543b when lever 541 is rotated. Furthermore, stripped portion 502a will contact the blade 521 during operation, resulting in the scratching and cleaving of the fibres.

During the first stage of operational use of lever 541 (as described above), clamping portions 542 contact unstripped portions 502b′ and 502b″, thereby clamping the ribbon 502 in place prior to the cleaving of the fibres.

The use of window stripping in this context has numerous advantages, in particular when using a cleaving tool with an additional tensioning mechanism 519. Firstly, by leaving two unstripped portions 502b′ and 502b″, the clamping portions 542 may only rest on unstripped portions of the ribbon, rather than resting directly on unsheathed fibre. This allows higher clamping forces to be applied since there is a reduced risk of snapping the fibres. This reduces slippage of the ribbon during the cleaving process, resulting in a higher quality cleave. Furthermore, it allows the clamping forces to be evenly distributed across all of the fibres within the ribbon. This ensures that tension is maintained equally in every fibre within the ribbon, again resulting in a higher quality cleave which is consistent across each fibre.

Another advantage of the use of window stripping in this context is to prevent the fibres from rolling during cleaving. Fibres that are sheathed are secured to one another, and fixed rotationally, unlike stripped fibres which are loose and unconnected from other fibres in the ribbon. Unstripped fibres therefore cannot roll when clamped, compared to stripped fibres. The rolling of fibres during cleaving is disadvantageous since this would mean that the resultant angled cleave would vary in orientation for each individual fibre. By preventing rolling, the angled ends of each fibre will share the same orientation.

The use of window stripping allows the end of the fibre ribbon to remain sheathed, thereby securing the fibres to one another during clamping, and preventing rolling during the cleaving process.

While FIGS. 14 and 15 depict cleaving tool 500 in use with a window-stripped optical fibre ribbon 502, it is appreciated that the same apparatus can be used for any form of optical fibre, including single fibres and those which have been conventionally stripped or end-stripped.

It will also be appreciated that ribbon optical fibre may be cleaved successfully using a cleaving tool as described in drawings FIG. 1 through FIG. 12, i.e. without the use of a discrete tensioning mechanism, in which the optical fibres are clamped by clamping means 342 and bent down by a single anvil 343 in to a recess 317 and on to a sharp blade 321 to cleave, as described above. Such cleaving without the use of a discrete tensioning device may use conventionally end-stripped fibre ribbon or may use window stripped fibre ribbon.

In further embodiments (not shown), one or more additional retaining means may be provided to retain the fibre or fibres against the datum plane. For example, in some embodiments the distance between the clamping means 542 may be changed by changing the position of one or both of the clamping portions relative to the blade 321, 521. For example, in some applications it may be desirable to provide a cleaved fibre with a long stripped end. Thus, by moving the position of the clamping means 342, 542, the clamping can still be performed on the sheathed portions of fibre. In such embodiments, additional retaining means may be provided to retain the fibre against the datum plane to ensure alignment of the fibre. The retaining means may be provided on the lever 341, 541. The retaining means may clamp the fibre or they may be purely to hold the fibre in position without applying a substantial clamping force.

It will be appreciated that the features of each aspect of the invention described herein may be combined with each other aspect without departing from the scope of the invention as claimed.

1. A cleaving tool for cleaving ribbon fibres comprising two or more optical fibres, the cleaving tool comprising:
a cutting assembly; and
a clamping means comprising a datum plane and at least one clamping portion, the clamping means configured to clamp two or more of the optical fibres against the datum plane; wherein
the clamping means is configured to apply an equal clamping force to each of the optical fibres within the ribbon fibre.

2. The cleaving tool according to claim 1, wherein the clamping means comprises a compressible surface, wherein in use, the compressible surface is compressed against the optical fibre by less than the diameter of the optical fibre.

3. The cleaving tool according to claim 1, wherein the cleaving tool comprises a body portion, and wherein
the datum plane is integrally formed on a surface of the body portion.

4. The cleaving tool according to claim 3, wherein the cutting assembly comprises a blade and a blade securing means.

5. The cleaving tool according to claim 4, wherein the body portion comprises a channel or recess comprising a guide surface adjacent and perpendicular to the datum plane, and wherein the blade securing means is configured to secure the blade to or against the guide surface.

6. The cleaving tool according to claim 5, wherein the blade comprises a positioning recess or aperture and wherein the blade securing means comprises a blade-clamping portion configured to bias the blade against the guide surface.

7. The cleaving tool according to claim 4, further comprising an offset adjustment mechanism configured to adjust the position of the blade relative to the datum plane.

8. The cleaving tool according to claim 1, wherein the clamping means is configured to clamp an optical fibre in a first and second position against the datum plane and on opposite sides of the cutting assembly.

9. The cleaving tool according to claim 2, wherein the compressible surface, in use, is compressed against the optical fibre by less than 125 microns;
wherein the compressible surface has a Shore A hardness of 60 to 85; and
wherein the compressible surface comprises an elastomer.

10. (canceled)

11. (canceled)

12. The cleaving tool according to claim 2, wherein the clamping means comprises a first clamping portion and a second clamping portion, each clamping portion comprising the compressible surface.

13. The cleaving tool according to claim 12, wherein the first and second clamping portions clamp the optical fibre independently of each other; and
wherein, in use, the first and second clamping portions are configured to clamp the optical fibre simultaneously.

14. (canceled)

15. The cleaving tool according to claim 1, wherein the clamping portion comprises first and second arms, said first and second arms hingedly connected to the datum plane.

16. The cleaving tool according to claim 15, wherein the first and second arms share a pivot axis and further comprise a bridging portion connecting the first and second arms.

17. The cleaving tool according to claim 1, further comprising a comb, the comb configured to hold the two or more optical fibres parallel to each other.

18. The cleaving tool according to claim 1, further comprising a recess for receiving an optical fibre housing, configured so that an optical fibre extending from the optical fibre housing lies on the datum plane.

19. The cleaving tool according to claim 1, further comprising a tensioning mechanism configured to increase the tension within the one or more optical fibres during a cleaving operation.

20. A cleaving tool for cleaving optical fibres, the cleaving tool comprising:
a cutting assembly; and
a clamping means comprising a datum plane and at least one clamping portion configured to clamp one or more optical fibre or fibres against the datum plane; and
a tensioning mechanism configured to increase the tension within the one or more optical fibres during a cleaving operation.

21. The cleaving tool according to claim 20, wherein the tensioning mechanism comprises a tensioning rod located at or adjacent to the datum plane, a first anvil and a second anvil.

22. The cleaving tool according to claim 21, wherein the first anvil and the second anvil are configured to contact the one or more optical fibres on opposite sides of the tensioning rod.

23. A cleaving tool for cleaving optical fibres, the cleaving tool comprising:
a cutting assembly; and
a clamping means comprising a datum plane and at least one clamping portion configured to clamp at least one optical fibre against the datum plane; wherein
the clamping means comprises a compressible surface, wherein in use, the compressible surface is compressed against the at least one optical fibre by less than the diameter of the optical fibre.
